(19) United States
(12) Patent Application Publication
(10) Pub. No.: US 2025/0385428 A1
(43) Pub. Date: Dec. 18, 2025

(54) ROTATION DEVICE FOR RADAR EQUIPMENT, AND RADAR EQUIPMENT INCORPORATING SUCH A DEVICE

(71) Applicant: ELETTRONICA MARITTIMA S.R.L., Mesola (IT)

(72) Inventors: Enrico Ghezzo, Ferrara (IT); Enrico Lenzi, Mesola (IT)

(21) Appl. No.: 19/144,603

(22) PCT Filed: Dec. 29, 2023
(86) PCT No.: PCT/IB2023/063373

§ 371 Date: Jun. 30, 2025

(30) Foreign Application Priority Data
Dec. 30, 2022 (IT) 102022000027249

(51) Int. Cl. H01Q 3/04; G01S 7/03; G01S 13/937; H02K 7/14

(52) U.S. Cl. CPC H01Q 3/04; G01S 7/03; G01S 13/937; H02K 7/14

(57) ABSTRACT

A rotation device (100) for a radar equipment (1) is shown by which a rotary joint (4) can be obtained without sliding contacts. In particular, a motor unit (110) is installed on an antenna module (3) in an inverted position with respect to a conventional assembly, with a stator (111) of the motor unit (110) integral with the antenna module (3) and a movable part (41) of the rotary joint (4); a device for transmitting electrical power (200) from the base (2) to the antenna module (3), realized by means of a transmitting inductor (203) and a receiving inductor (204), integral to a stationary part (40) and a movable part (41) of the rotary joint (4), respectively; a signal transfer device (300) first and second electro-optical conversion circuitry, associated respectively to the stationary part of the rotary joint (4) and to the movable part of the same rotary joint (4).

### TECHNICAL FIELD

The present invention relates to the technical field of radars, in particular, but not exclusively, of the type that can be used for short and medium distances and on land vehicles or boats in order to plumb the surrounding areas, to detect in good time possible obstacles to running or navigation or other presences that for any reason may represent a danger.

In particular, the invention relates to a novel device for powering the antenna module of a radar, in which such antenna module is aimed at performing rotations with respect to its support base.

### TECHNICAL PROBLEM

The above-mentioned radars of the known type are mainly used for military applications, although they are also suitable for civil use, in particular with regard to navigation of boats or in the “automotive” field; for the latter applications, there are versions of the radar with a very short range for detecting obstacles in parking operations or for assisting driving in the most demanding passages.

By way of a pure example of the application of the present invention, one of the most commonly used types of radar on short to medium range is FM/CW technology (‘Frequency Modulation/Continuous Wave Radar’), which exploits the reflection of a frequency-modulated signal, continuously radiated by a transmitting antenna, on a target (or obstacle).

The signal reflected from the target is received by a receiving antenna and compared with the transmitted signal. Since the modulation of the transmitted signal varies continuously over time, particularly with regard to its frequency, the result of the comparison between the modulated content carried by the transmitted and received signals is the duration of flight and, consequently, the distance to the target.

According to the operating technology of the aforementioned radars, the comparison between the modulated contents of the transmitted signal and received signal takes place in the ‘baseband’, i.e. in the same frequency band as the modulation, due to a simple ‘zero IF’ conversion operation, i.e. without the passage to intermediate frequencies required in traditional frequency conversion schemes, but by converting the same signal. In electronics, this process, known to those skilled in the art, is called ‘homodyne’ and allows to simplify considerably the circuit and thus to reduce significantly costs and space.

A radar of the type indicated above, realized according to the known technique, comprises the following functional blocks:
a signal generator having suitable power;
a transmitting antenna;
a receiving antenna;
a baseband conversion circuit;
a demodulated signal acquisition and processing circuit;
a dedicated processor, residing in the antenna module, in which a software operates for extracting information and representing targets;
a software for communication between the aforementioned dedicated computer and at least one external computer, present in an operating station, aimed at transmitting to the latter, among other things, the aforementioned information and representation of targets;
a rotary joint with sliding contacts, generally made of metal materials because of stress resistance;
a motor, possibly with a reduction gear, for rotating the module comprising the two antennas, transmitter and receiver.

Structurally, such a radar consists of a fixed base, to be bracketed to the vehicle or boat, and a rotating antenna module, comprising both the transmitting and receiving antennas, supported by the fixed base by means of the aforementioned rotary joint.

In the constructive solutions of the prior art, for reasons of manufacturing convenience, the antenna module houses the electronic components that manage the radiofrequency signals, in transmission and reception, and often also the electronic circuit that processes the signal extracted from the conversion, while the fixed base contains the electronic circuits for powering the motor, other components and antennas, as well as any additional electronic circuits for interfacing and transmitting data between the same radar and a remote operating station, typically and preferably through the Internet supported by an Ethernet-type physical connection.

The most commonly used transmission standard is the one called BaseTX (Fast Ethernet, or MLT-3), in which the signal is handled in analog form with coding on three different voltage levels. This increases the line transmission capacity in comparison with the more conventional two-level Manchester coding.

The rotary joint with sliding contacts, therefore, is a fundamental component for assuring the necessary electrical connection between the parts of the radar that remain stationary and the rotating ones, particularly if this rotation is a continuous 360° rotation and not in angular sectors according to alternating directions, and much of the performance of the radar itself depends on the joint efficiency.

For this purpose, the rotary joint must provide a suitable number of sliding contacts, as many as are needed for the electrical connection between the circuit parts contained in the fixed base and those contained in the rotating antenna module.

Again, according to the prior art, the motor is housed in the fixed base of the radar, in order to facilitate its connection with the power supply circuit, whereas the connection with the electronic circuit for controlling speed and angular position, usually housed in the antenna module, must be made by corresponding sliding contacts of the rotary joint.

Additional sliding contacts of the rotary joint are necessary to transfer at least one data line from the antenna module to the base, and thus to the operating station, usually consisting of a physical Ethernet line, thereby increasing the total number of required sliding contacts of the rotary joint.

The power supply required for the operation of all electrical and electronic devices in the antenna module must also be transferred through the rotary joint. In this case, besides the problems mentioned above, there is also the problem of guaranteeing the stability and reliability of the sliding contacts connecting the power supply also for the high currents required to supply the aforementioned devices.

As can be intuitively understood, the constructive solution with sliding contacts involves a non-negligible complexity of construction, which increases with the number of contacts required for the transit of signals and power supplies.

Moreover, these sliding contacts are subject to wear and corrosion, and thus to a progressive degradation of their reliability over time; in order to at least limit these drawbacks, it is necessary to use noble metals, such as gold, which raises the cost of such rotary joints.

Obviously, even the failure of just one of the various sliding contacts in a rotary joint makes it necessary to replace it, with the consequent costs.

The sliding contacts, especially if they are not made perfectly and with high quality materials, can also produce electrical noise during operation, especially after a long period of use, which can disturb the operation of the electronics managing the transmission and reception of the radar signal.

Japanese Patent No. JP5 727146 B2 discloses a device for powering a radar apparatus, comprising a fixed part and a rotating part containing the antenna, and providing for inductive transmission of the power to the antenna itself and optical transmission of the data signals between the fixed part and the rotating part.

Chinese Patent Application Publication No. CN 107 436 425 discloses a radar apparatus comprising a fixed base and a rotating platform, at one end of which is mounted an antenna for transmitting and receiving radar signals. The aforementioned patent application describes a motor for driving the rotating platform in which the stator is fixed to the latter, while the rotor is connected to the fixed base.

European Patent EP 1 241 732 B9 discloses an antenna apparatus provided with a waveguide rotary coupler, in which the power to the rotating part is supplied by means of an induction transformer.

U.S. Pat. No. 10,109,183 B1 discloses an interface for data transfer between a non-rotating body and a rotating body, where such transfer occurs by means of electro-optical couplers.

### OBJECTS OF THE INVENTION

The main object of the present invention is to eliminate the presence of sliding contacts in the transmission of the power and control signals of the motor unit responsible for the rotation of the antenna module.

Another object of the invention is to propose an improved radar, in particular for short and medium ranges, capable, in general, of improving performance, reliability and efficiency of the transfer of electrical and data signals from the antenna module to the base of the radar.

A further object of the invention is to eliminate the presence of sliding contacts in the transmission of the general power supply, from the base to the antenna module, aimed at powering the electrical and electronic devices in the aforementioned antenna module.

A still further object of the invention is to eliminate the presence of sliding contacts in the transmission and reception of operational data exchanged between the antenna module and the radar base, and between the antenna module and the operating facility.

### SUMMARY OF THE INVENTION

These and other objects are fully achieved by a driving device for radar equipment, and by a radar equipment incorporating the driving device, said radar equipment being in particular a FM/CW radar for short and medium ranges, particularly suitable for installation on vehicles or boats, and of the type comprising: a base, made integral with the structure of the vehicle or boat; an antenna module, comprising a transmitting antenna section and a receiving antenna section and connected to said base with the possibility of rotation about a predefined, usually vertical, axis; a rotary joint, provided for the rotating support of the aforementioned antenna module with respect to said base and for the simultaneous transmission of electrical and data connections between said base and the aforementioned antenna module, said rotary joint comprising a stationary part, integral with said base, and a movable part, integral with said antenna module; at least one electronic module resident in said antenna module for the generation, transmission, reception and management of antenna signals; at least one communication data line passing through said base to connect said antenna module and an operating facility, with the interposition of signal transfer means associated to the aforementioned rotary joint; said driving device comprising a motor unit, comprising in turn at least one stator and at least one rotor, aimed at driving said antenna module so as to rotate continuously or in angular sectors according to alternating directions, with respect to the above mentioned base; an electronic drive and control circuit of said motor unit; at least one power supply line, aimed at powering said electronic antenna signal module and said electronic drive and control circuit of the motor unit, said supply line extending between said base and said antenna module with interposition of electric power transfer means associated with said rotary joint.

In particular, in the above-mentioned driving device:
the stator of the above-mentioned motor unit is integral with said antenna module and with the movable part of the above mentioned rotary joint;
the rotor of the above-mentioned motor unit is mechanically connected to the stationary part of said rotary joint;
the aforementioned electronic drive and control circuit is contained in the above-mentioned antenna module;
the control and power connections of said motor, originating from said electronic drive and control circuit and electrically connected to said stator, are entirely contained within the above-mentioned antenna module.

### BRIEF DESCRIPTION OF THE DRAWINGS

The characteristics of the invention will be apparent from the following description of preferred embodiments of the driving device for a radar equipment, and of the radar equipment incorporating this device, as set forth in the subject matter, in accordance with the content of the claims and with the help of the appended drawings, in which:

FIG. 1 illustrates, in a schematic side view, a radar equipment with the driving device of the invention, associated with a rotary joint which supports the antenna module with respect to the base of the same radar equipment;

FIG. 2 illustrates a schematic plan view of the equipment of FIG. 1;

FIG. 3 illustrates an axonometric view of the driving device and the rotary joint;

FIG. 4 illustrates, in a plan view, the same components depicted in FIG. 3;

FIG. 5 illustrates a sectional schematic side view of the aforementioned driving device and rotary joint;

FIG. 6 illustrates a schematic block view of the radar equipment, showing the various functional groups, located in the antenna module and in the base, and their electrical interconnections also through said rotary joint.

### DESCRIPTION OF PREFERRED EMBODIMENTS OF THE INVENTION

In the above-mentioned figures, reference number 100 indicates the driving device proposed by the present invention and applied to a radar equipment 1.

In particular, by way of example, the aforesaid radar equipment 1 is a FM/CW (“Frequency Modulation/Continuous Wave Radar”) radar equipment, suitable for short and medium ranges, which has already been mentioned in the introduction. However, it is understood that the present invention can also be applied in different types of radar equipment, both of the continuous wave and of the pulsed wave type.

A radar equipment 1 of the disclosed type is particularly suitable for installation in vehicles or boats (not illustrated), and substantially comprises:
a base 2, intended to be made integral with the structure of the vehicle or boat, comprising an outer box-like container, preferably of a flattened shape, and a series of electrical and electronic components housed therein, discussed in more detail below;
an antenna module 3, for example of a double flag shape, comprising thereinside a section of the transmitting antenna section Tx and a section of the receiving antenna section Rx, with the antenna module 3 being connected to said base 2 with possibility of rotation around a predefined Y axis, usually vertical;
a rotary joint 4, provided for the rotatable support of the above mentioned antenna module 3 with respect to the base 2, comprising a stationary part 40, integral with said base 2, and a movable part 41, integral with said antenna module 3, with the same rotary joint 4 also equipped with means for making electrical connections and transmitting data between said base 2 and the aforementioned antenna module 3, and vice versa;
at least one electronic module 5 for the generation, transmission, reception and management of antenna signals, resident in said antenna module 3;
an aforementioned driving device 100, proposed by the present invention, the structure of which will be detailed below, mechanically connected to the above-mentioned base 2 and antenna module 3 so as to drive said antenna module 3 into rotation in a controlled way;
a power supply line 8, aimed at supplying power to the aforementioned electronic module 5 for managing antenna signal and driving device 100. The power supply line 8 extends between the base 2 and the antenna module 3 and is provided with an electrical power transmission device 200 associated with the rotary joint 4. The transmission device 200 is intended to transfer electrical power between the base 2 and the antenna module 3, through the rotary joint 4, in a reliable way and substantially independent of the wear of the rotary joint 4 itself;
at least one data communication line 6 extending between the antenna module 3 and a remotely located operating facility 60 intended to receive operational data from the radar 100, via the aforesaid base 2. The bidirectional data communication line 6 preferably comprises an Ethernet line extending between the antenna module 3 and the operating station 60 and is provided with a signal transfer device 300 associated with the aforementioned rotary joint 4, in a reliable way and substantially independent of wear and tear of the rotary joint 4 itself.

The driving device 100 proposed by the invention comprises:
a motor unit 110, comprising in turn at least one stator 111 and at least one rotor 112, aimed at driving said antenna module 3 to rotate continuously or in angular sectors according to alternating directions with respect to the above mentioned base 2; and
an electronic drive and control circuit 107 of the above mentioned motor unit 10.

According to the invention, the assembly configuration of the drive device 100 is such that:
the stator 111 of the motor unit 110 is integral with the antenna module 3 and the above-mentioned movable part 41 of the rotary joint 4;
the rotor 112 of the motor unit 110 is mechanically connected to the stationary part 40 of said rotary joint 4;
the aforementioned electronic drive and control circuit 107 is contained in the above-mentioned antenna module 3;
the control and power connections of said motor, originating from said electronic drive and control circuit 107 and electrically connected to said stator 111, are entirely contained within the above-mentioned antenna module 3.

In a preferred embodiment of the driving device 100, illustrated in the appended figures, the stator 111 of the motor unit 110 is attached to the body of the antenna module 3 with a parallel axis and an offset position with respect to the axis of rotation Y of the antenna module, i.e. of the rotary joint 4, while the rotor 112 of the motor unit 110 is mechanically connected to the stationary part 40 of the rotary joint 4 with the interposition of speed reduction means 113.

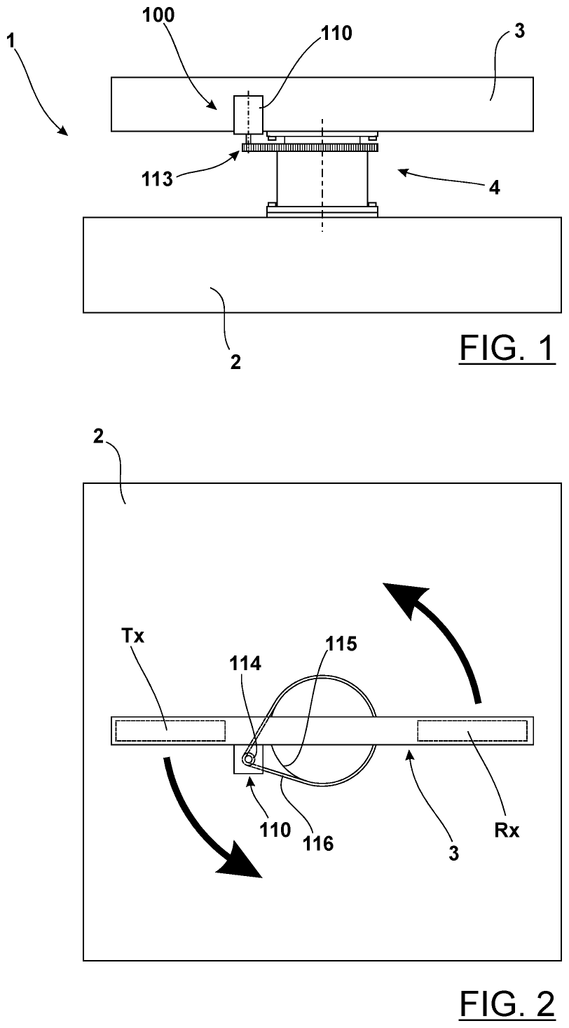

More in particular, said speed reducers 113 comprise a pulley 114, keyed at the output on the shaft of said rotor 112, a crown wheel 115 made outside a sleeve 40E, coaxial and integral to said stationary part 40 of the rotary joint 4, and consequently integral with the base 2, and finally, a toothed belt 116 which engages with the pulley 114 and with the crown wheel 115 (FIGS. 1, 2, 3).

Since the crown wheel 115 is stationary, the rotation of the rotor 112 and the pulley 114 is transformed, by means of the toothed belt 116, into a revolution motion of the drive unit 110 around the Y axis of the same crown wheel 115 as well as the rotary joint 4.

Consequently, the entire antenna module 3 is driven to rotate with respect to the same Y-axis of the rotary joint 4 (FIG. 2).

For the purposes of the present invention, the motor unit 110 is of the “brushless” stepper type, which allows for precise and continuous positional control.

It should be noted that the conformation, as illustrated, of the elements that form the rotary joint 4, has been deliberately schematized in order to more intuitively render the understanding of the aforementioned electric power transfer device 200 and signal transfer device 300, which are associated with the rotary joint 4 and which will also be described below. Therefore, there is no reason not to use different final designs of these elements in combination, while respecting what is specified in terms of operation.

In an alternative, not illustrated embodiment of the driving device 100, the motor unit 110 is arranged with a horizontal axis, with the stator 111 fixed to the body of the antenna module 3 and with the rotor 112 having a worm gear keyed at the output, tangentially meshed with the aforementioned crown wheel 115, for this purpose provided with helical teeth.

The rotation of the rotor 112 and of the coaxial worm gear determines, similarly to what has been said above, a revolution motion of the motor unit 110 around the axis Y of the rotary joint 4 with consequent rotation of the antenna module 3.

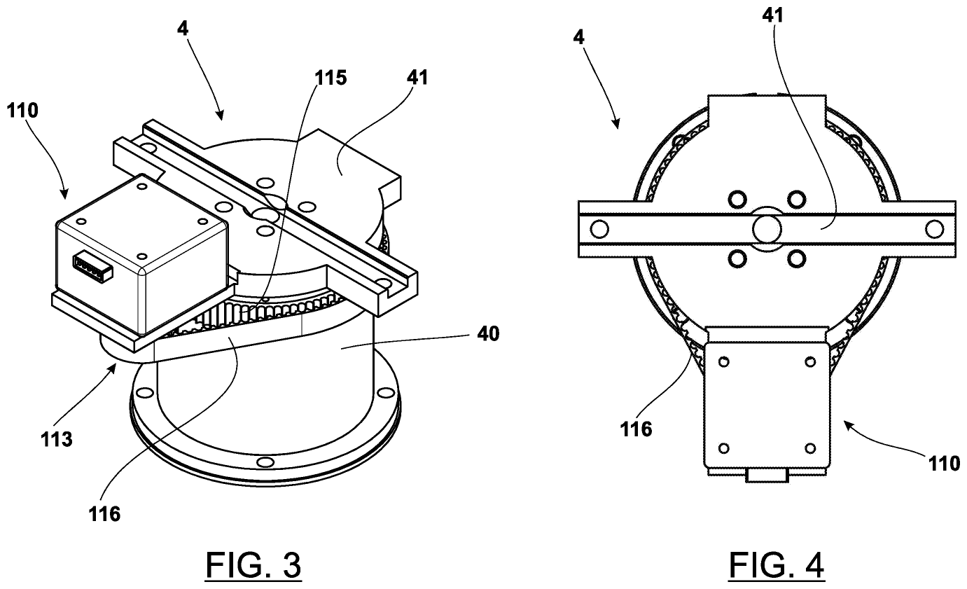

For reasons which will become apparent in the following description, the rotary joint 4 is advantageously made in such a way that its stationary part 40 is arranged internally to the complementary movable part 41, and that suitable bearings 42 are interposed between the same parts 40, 41, for example ball bearings or roller bearings (see in particular FIG. 3); moreover, it is crucial that said rotary joint 4 is entirely made of electrically non-conductive materials, for example composite materials.

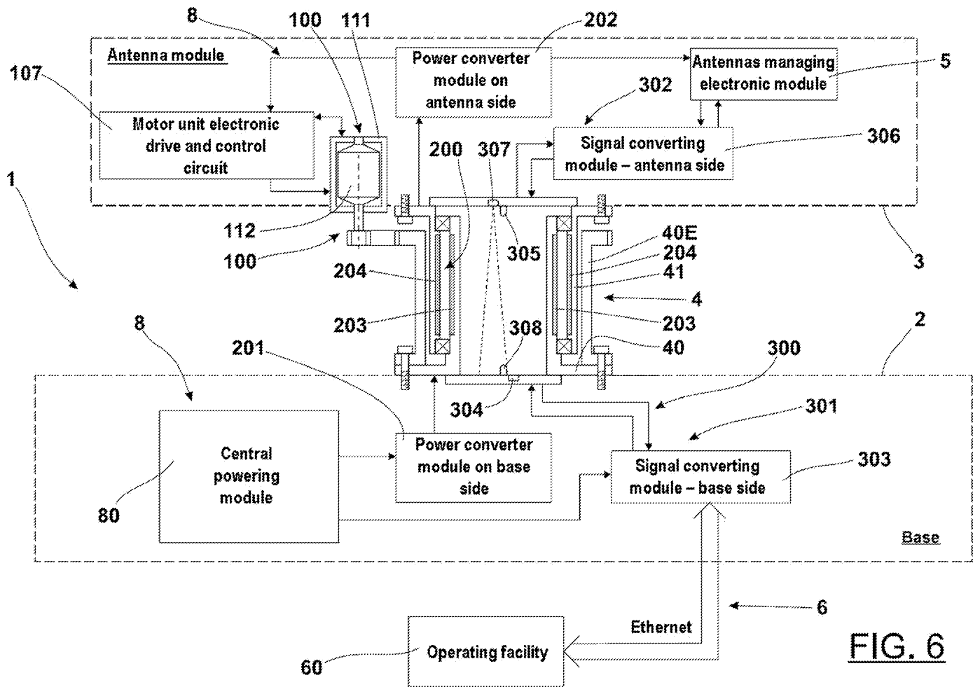

The electrical power supply line 8, as outlined in FIG. 6 and in a manner known per se, comprises a central power supply module 80 of a substantially known type, housed in the base 2 of the radar 1, and the aforementioned electrical power transmission device 200, the components of which reside partly in the base 2, partly in the aforementioned rotary joint 4 and partly in the aforementioned antenna module 3.

In particular, the power transmission device 200 comprises a first power converter module 201 housed in the base 2, aimed at converting the direct current supply into alternating current of an appropriate frequency, as will be further detailed below.

The power transmission device 200 further comprises a second power converter module 202 housed in the antenna module 3, aimed at converting alternating current into direct current, of suitable strength, to power the aforementioned electronic module 5 of antenna signals and electronic drive and control circuit 107 of the motor unit 110 and therefore, also the latter motor unit 110.

A transmitting inductor 203, electrically connected at the output of the aforementioned first power converter module 201, is also a part of the power transmission device 200, aimed at generating a variable electromagnetic field whose intensity is dimensioned so as to allow the necessary power transfer. The transmitting inductor 203 is associated and integral with the stationary part 40 of the rotary joint 4.

A receiving inductor 204 is also electrically connected at the inlet of the aforementioned second power converter module 202 and associated with and, in particular, integral with the movable part 41 of the rotary joint 4.

The receiving inductor 204 is intended to interact with the aforementioned electromagnetic field generated by the transmitting inductor 203 to generate an induced current, whose intensity depends on the intensity of the same electromagnetic field and is dimensioned so as to be able to supply power to the electric utilities connected to the second power converter module 202.

The dimensioning of the aforementioned transmitting inductor 203 and receiving inductor 204, as well as the currents circulating therein and the generated electromagnetic induction field, is part of the technical background of any industrial designer of average experience and will not be further discussed below.

More in detail, both the transmitting inductor 203 and the receiving inductor 204 have a cylindrical annular shape and are coaxial with each other, the transmitting inductor 203 being located internally to the receiving inductor 204, so as to be totally enclosed by the latter in order to maximize mutual electromagnetic coupling.

The transmitting inductor 203 is powered by the first power converter module 201 of the base 2 with a variable current which causes, due to electromagnetic induction, the generation of an induced current in the receiving inductor 204, which is then sent to the aforementioned second power converter module 202 in the antenna module 3. The latter converts the induced current into direct current, which powers said electronic drive and control circuit 107, and thus the motor unit 110, and also the aforementioned electronic module of antenna signals 5, as well as any other electrical or electronic components provided in the antenna module 3.

For proper operation, the oscillation frequency of the current supplied to the above-mentioned transmitting inductor 203 is significantly higher, for example of about 200 KHz, than the operating frequency of the above-mentioned radar equipment 100, which is generally expected to be of about 125 KHz. Suitable filters can be provided in the aforementioned electronic module for signal generation and management 5 and in the aforementioned drive circuit 107 of the drive unit to eliminate any interference caused by residues present at the operating frequencies of the power transfer signal.

In the above-mentioned radar equipment 1, the above-described signal transfer device 300, provided in the above mentioned data communication line 6, comprises a first electro-optical conversion circuitry 301, associated with the stationary part 40 of the rotary joint 4, and a second electro-optical conversion circuitry 302, associated with the movable part 41 of the same rotary joint 4.

Each of the aforementioned first conversion circuitry 301 and second conversion circuitry 302 is aimed at converting the electrical signals coming from the data communication line 6 from the levels provided in its standard into as many levels of optical signal and at transmitting them to the opposite circuitry, and at reconverting corresponding optical signal levels coming from the aforementioned opposite circuitry into as many electrical signals according to the standard of the same data communication line 6.

In this regard, the first electro-optical conversion circuitry 301 comprises a first signal converter module 303, housed in the base 2, and a first LED emitter 304, integral with said stationary part 40, aimed at generating its own optical signal oriented towards the second circuitry 302. A first photoreceptor 305, provided in the second circuitry, is integral with said movable part 41, aimed at intercepting the above mentioned optical signal from the first LED emiiter 304.

In a similar way, the second electro-optical conversion circuitry 302 includes a second signal converter module 306, housed in the antenna module 3, and a second LED emitter 307, integral with said movable part 41, aimed at generating its own optical signal oriented towards said first circuitry 301. A second photoreceptor 308, provided in the first circuitry, is integral with the above-mentioned stationary part 40 and is aimed at intercepting the optical signal coming from the second LED emitter 307.

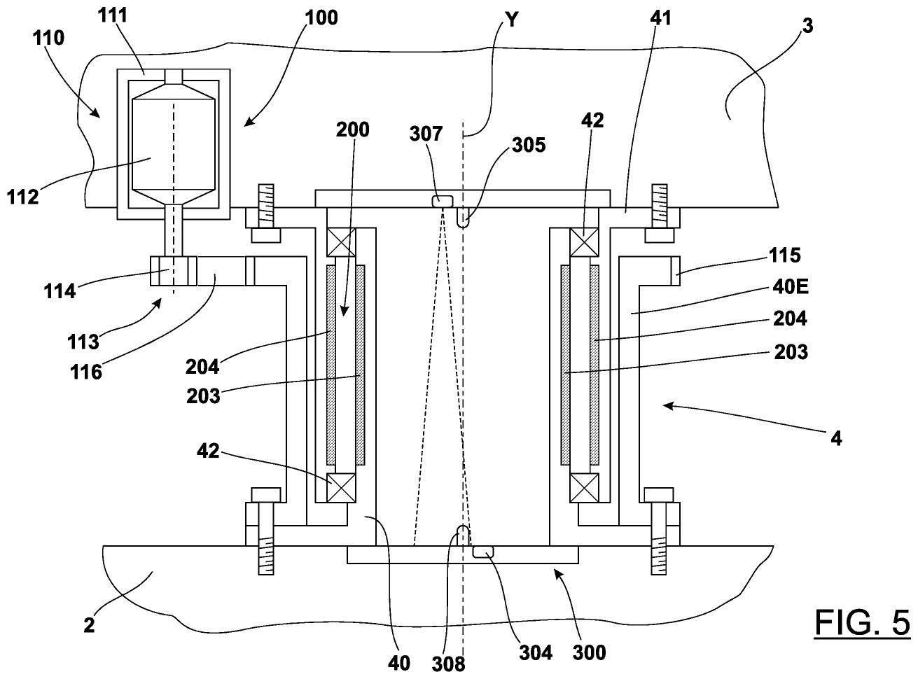

Dotted lines of FIGS. 5 and 6 outline the emission cone of the signal produced by the aforementioned second LED emitter 307, whose angle is calibrated so as to cover the existing difference in alignment with the second photoreceptor 308.

Likewise, the first LED emitter 304 also produces a signal with an emission cone such as to cover the alignment difference with respect to the first photoreceptor 305.

Advantageously, the LED emitters 304, 307 as well as the photoreceptors 305, 308 are placed at the empty central area of the rotary joint 4, so that the respective optical signals are not disturbed by any barrier.

It is envisaged that, in the radar equipment 1, the aforementioned data communication line 6 is an Ethernet one, with three-level signal encoding, respectively with positive, null and negative polarity: advantageously, these signal levels are transposed by the aforementioned first electro-optical conversion circuit 301 and second electro-optical conversion circuit 302 to as many brightness levels of the respective first emitting LEDs 304 and second emitting LEDs 307, aimed at being captured and interpreted, without any physical contact, by the corresponding first photoreceptor 305 and second photoreceptor 308.

More precisely, the above-mentioned three brightness levels correspond to a maximum brightness level, a medium brightness level and a zero brightness level.

The above description clearly shows the peculiarities of the proposed invention, which makes it possible, by means of original constructive solutions, to totally eliminate the presence of sliding contacts in the rotary joint.

The arrangement of the motor unit, mounted on the antenna module and therefore overturned with respect to the usual practice, makes it possible, at the same time, to limit the connection between the base and the antenna module, realized by means of the described transmitting and receiving inductors provided in the rotary joint, only to the transmission of the power supply, as well as to facilitate the transmission of the powering and control signals of the same motor unit, since the relative components are all located in the antenna module.

The other electrical and electronic devices in the aforementioned antenna module are also powered by the induced current generated without contact by the aforementioned inductors, which acts as the general power supply.

It should be emphasised that this original arrangement of the motor unit was combined with equally novel transmission components to drive the antenna module to rotate, advantageously leaving empty the central area of the rotary joint.

The aforementioned empty central zone of the rotary joint allows to conveniently position the signal transfer means with the LED emitters and photoreceptors for the transmission and reception, clearly without physical contact, of the operational data exchanged between the antenna module and the radar base, and between the antenna module and the operating facility.

The introduction of the signal transfer device 300 described above also makes it possible, advantageously, to avoid, in the transmission of the signals relative to the data communication line 6, the presence of analog-to-digital and digital-to-analog conversion devices, which are provided in conventional radar equipment.

In essence, the rotary joint transmits, by induction, only the electrical power signal and the optical signal exchanged between the emitting LEDs and the photoreceptors.

Thanks to these fundamental characteristics, which simplify the construction and eliminate the criticalities caused by rotary joints with sliding contacts, an improved radar is obtained, particularly for short and medium ranges, with better overall performance than radars of known technology, in particular in terms of reliability over time and efficiency in the transfer of electrical and data signals from the antenna module to the base of the radar.

In particular, the introduction of the above-described driving devices 100, power transfer devices 200 and signal transfer devices 300, obtained according to what has been described above and claimed below, makes it possible to totally eliminate the presence of sliding contacts in the rotary joint 4, and therefore, to make it more reliable, more long-lasting and less subject to the generation of electrical noise during the operation.

However, it is understood that what is described above is illustrative and not limiting, therefore, any detail variations that may be necessary for technical and/or functional reasons are considered from now on within the same protection scope defined by the claims below.

1. A driving device of a radar equipment, said radar equipment (1) suitable for installation in a vehicle or boat and comprising: a base (2), fit to be fixed to a structure of the vehicle or boat; an antenna module (3), comprising a transmitting antenna section (Tx) and a receiving antenna section (Rx) and connected to said base (2) with the possibility of rotation about a predetermined axis (Y); a rotary joint (4), provided for the rotatable support of said antenna module (3) with respect to said base (2) and for the simultaneous transmission of electrical and data connections between said base (2) and said antenna module (3), said rotary joint (4) comprising a stationary part (40), integral with said base (2), and a movable part (41), integral with said antenna module (3); at least one electronic module (5) for the generation, transmission, reception and management of the antenna signals, resident in said antenna module (3); at least one communication data line (6) between said antenna module (3) and an operating facility (60), through said base (2), with interposition of signal transfer means (300) associated to said rotary joint (4); said driving device (100) comprising a motor unit (110), in turn comprising at least one stator (111) and at least one rotor (112), aimed at driving said antenna module (3) to rotate continuously, or in angular sectors according to alternating directions, with respect to said base (2); an electronic drive and control circuit (107) of said motor unit (110); at least one power supply line (8), aimed at supplying said electronic antenna signal module (5) and said electronic drive and control circuit (107) of said motor unit (110), extending between said base (2) and said antenna module (3) with the interposition of an electrical power transfer device (200) associated with said rotary joint (4); said drive device (100) wherein:
the stator (111) of said motor unit (110) is integral with said antenna module (3) and with the movable part (41) of said rotary joint (4);
the rotor (112) of said motor unit (110) is mechanically connected to the stationary part (41) of said rotary joint (4);
said electronic drive and control circuit (107) is contained in said antenna module (3);
the control and power connections of said motor unit (110), originating from said electronic drive and control circuit (107) and (7) electrically connected to said stator (111), are entirely contained within said antenna module (3); and wherein:
said electrical power transfer device (200) comprises a pair of inductors, a transmitting inductor (203) and receiving inductor (204), associated with said stationary part (40) and said movable part (41) of the rotary joint (4), respectively, said receiving inductor (204) configured for electromagnetic coupling to said transmitting inductor (203) and arranged coaxially and internally thereto;
said transmitting inductor (203) mounted internally to and contained by said receiving inductor (204), wherein said transmitting inductor (203) and receiving inductor (204) have cylindrical symmetry; and
said signal transfer device (300), provided in said data communication line (6) comprises: a first electro-optical conversion circuitry (301), associated with said stationary part (40) of the rotary joint (4), and a second electro-optical conversion circuitry (302), associated with said movable part (41) of the rotary joint (4); said first electro-optical conversion circuitry (301) and said second electro-optical conversion circuitry (302) configured for converting electrical signals coming from said data communication line (6) into optical signal levels for transmission to opposite side conversion circuitry (301, 302), and for converting corresponding optical signal levels coming from said opposite side conversion circuitry into electrical signals according to a standard of said data communication line (6).

2. The driving device according to claim 1, wherein the stator (111) of said motor unit (110) is fixed to the body of said antenna module (3) and is therefore connected to the movable part (41) of said rotary joint (4), integral therewith, with parallel axis and offset position with respect to the predetermined axis (Y) of said rotary joint, and wherein the rotor (112) of said motor unit (110) is mechanically connected to the stationary part (40) of said rotary joint (4) with interposition of speed reduction means (113).

3. The driving device according to claim 2, wherein said speed reduction means (113) comprise a pulley (114), keyed at an output to the shaft of said rotor (112), a crown wheel (115) made on an outer part of a sleeve (40E) integral with said stationary part (40) of said rotary joint (4), and consequently, integral with said base (2), and finally a toothed belt (116) engaging said pulley (114) and crown wheel (115).

4. The driving device according to claim 1, wherein said transmitting inductor (203) is electrically connected, with variable current, to an output of a first power converter module (201) arranged in said base (2); said receiving inductor (204) is also electrically connected to an input of a second power converter module (202), arranged in said antenna module (3) for receiving, from said receiving inductor (204), an induced current generated thereby due to interaction with said transmitting inductor (203) for conversion into a supply of direct current.

5. (canceled)

6. (canceled)

7. The driving device according to claim 1, wherein an oscillation frequency of the variable current supplied to said transmitting inductor (203) is significantly higher than an operating frequency of said radar equipment (1).

8. The driving device according to claim 1, wherein said rotary joint (4) is made entirely of electrically non-conductive materials.

9. (canceled)

10. The driving device according to claim 9, claim 1, wherein said first electro-optical conversion circuitry (301) comprises a first LED emitter (304), integral with said stationary part (40), aimed at generating said optical signal oriented towards said second electro-optical conversion circuitry (302), said second electro-optical conversion circuitry provided with a first photoreceptor (305), integral with said movable part (41), for intercepting a first optical signal produced by said first LED emitter (304); and wherein said second circuitry (302) comprises a second LED emitter (307), integral with said movable part (41), for generating a second optical signal oriented towards said first electro-optical conversion circuitry (301) provided with a second photoreceptor (308), integral with said stationary part (40), for intercepting an optical signal produced by said second LED emitter (307).

11. The driving device according to claim 1, wherein said data communication line (6) is an Ethernet line with three level signal encoding, respectively with positive, null and negative signals converted by said first electro-optical conversion circuit (301) and second electro-optical conversion circuit (302) to corresponding brightness levels of said first LED emitter (304) and said second LED emitter (307).

12. The driving device according to claim 11, wherein said brightness levels of said first LED emitter (304) and said second LED emitter (307) correspond to a maximum brightness level, an average brightness level and a zero brightness level.
